(19) United States
(12) Patent Application Publication
(10) Pub. No.: US 2026/0066543 A1
(43) Pub. Date: Mar. 5, 2026

(54) MULTILAYER SUBSTRATE AND ANTENNA DEVICE

(71) Applicant: Murata Manufacturing Co., Ltd., Nagaokakyo-shi (JP)

(72) Inventor: Kentaro KAWABE, Nagaokakyo-shi (JP)

(73) Assignee: Murata Manufacturing Co., Ltd., Nagaokakyo-shi (JP)

(21) Appl. No.: 19/381,158

(22) Filed: Nov. 6, 2025

Related U.S. Application Data
(63) Continuation of application No. PCT/JP2024/014504, filed on Apr. 10, 2024.

(30) Foreign Application Priority Data
May 17, 2023 (JP) 2023-081878

(51) Int. Cl. H01Q 13/08; H01Q 5/378

(52) U.S. Cl. CPC H01Q 13/08; H01Q 5/378

(57) ABSTRACT

A transmission line section of a multilayer substrate forms a stripline including an upper ground conductor, a lower ground conductor, and a signal line conductor. The antenna section includes a signal line conductor interlayer connection conductor that electrically connects the radiation conductor to the signal line conductor, and one or more ground conductor interlayer connection conductors that electrically connect an upper-surface annular ground conductor to the lower ground conductor and the upper ground conductor of the transmission line section. Viewed in the stacking direction of a plurality of base materials, the entire surface of the radiation conductor overlaps the lower ground conductor, and an end portion of the upper ground conductor is inside an annular shape formed by the upper-surface annular ground conductor at a position that overlaps the signal line conductor but does not overlap the radiation conductor.

### CROSS-REFERENCE TO RELATED APPLICATIONS

The present application is a continuation of PCT/JP2024/014504, filed Apr. 10, 2024, which claims priority to Japanese patent application JP 2023-081878, filed May 17, 2023, the entire contents of each of which being incorporated herein by reference.

### TECHNICAL FIELD

The present disclosure relates to a multilayer substrate and an antenna device including the multilayer substrate.

### BACKGROUND ART

Patent Document 1 discloses an antenna element relating to a multilayer substrate included in an antenna device or an antenna device including a multilayer substrate. Patent Document 1 discloses an antenna element including a multilayer body. The multilayer body is formed by stacking an insulator layer having a first ground conductor formed over substantially the entire surface thereof, an insulator layer having a radiating element formed in the center thereof and second ground conductors formed around the radiating element, a plurality of insulators having ground conductors formed around their peripheries, and an insulator layer having a lead-out conductor formed thereon. The multilayer body includes an interlayer connection conductor that electrically connects a tip of the lead-out conductor to a radiation conductor.

### CITATION LIST

### Patent Document

Patent Document 1: International Publication No. 2023/021929

### SUMMARY

### Technical Problems

A device in which an antenna section and a transmission line section are stacked one on top of the other as disclosed in Patent Document 1 can be used as a flexible lead device equipped with an antenna, and therefore a highly stable antenna section can be constructed and can be easily incorporated into a small electronic device.

However, because the majority of the radiation conductor overlaps an upper ground conductor, this configuration cannot be applied to a multilayer substrate in which the transmission line section has a stripline structure and a lower ground conductor also serves as part of the antenna section, or to an antenna device including such a multilayer substrate. For example, if the transmission line section has a stripline structure, it is not possible to generate an appropriate capacitance between a lower ground conductor thereof and the radiating element in order to achieve radiation characteristics at a desired frequency.

Accordingly, the present disclosure is directed to providing a multilayer substrate in which a transmission line section has a stripline structure and a lower ground conductor thereof also serves as part of an antenna section, and an antenna device including such a multilayer substrate.

### Solutions to Problems

(1) As an example of the present disclosure, a multilayer substrate includes an antenna section and a transmission line section.

The antenna section includes a plurality of base materials stacked on top of each other, the base materials including a base material provided with a radiation conductor and a base material provided with an annular ground conductor surrounding the radiation conductor in an annular fashion.

The transmission line section is configured to transmit signals related to the antenna section.

The transmission line section forms a stripline including an upper ground conductor close to the antenna section, a lower ground conductor distant from the antenna section, and a signal line conductor disposed between the upper ground conductor and the lower ground conductor.

The antenna section includes a signal line conductor interlayer connection conductor that electrically connects the radiation conductor to the signal line conductor, and a ground conductor interlayer connection conductors that electrically connect the annular ground conductor to the lower ground conductor and the upper ground conductor of the transmission line section.

When viewed in a stacking direction of the plurality of base materials, an entire surface of the radiation conductor overlaps the lower ground conductor.

When viewed in the stacking direction of the plurality of base materials, an end portion of the upper ground conductor is disposed inside an annular shape formed by the annular ground conductor at a position that overlaps the signal line conductor but does not overlap the radiation conductor.

(2) As an example of the present disclosure, an antenna device includes the multilayer substrate. The antenna device is connected to a communication circuit.

### Advantageous Effects

According to the multilayer substrate of the present disclosure, a multilayer substrate can be configured in which a transmission line section has a stripline structure and a lower ground conductor thereof also serves as part of an antenna section, and furthermore an antenna device including the multilayer substrate can be obtained.

### BRIEF DESCRIPTION OF DRAWINGS

FIGS. 1(A) and 1(B) are diagrams illustrating the structure of a multilayer substrate 101A of an antenna device according to a First Embodiment.

FIG. 2 is a vertical cross-sectional view of a multilayer substrate 101B according to the First Embodiment.

FIG. 3(A) is cross-sectional view of an antenna device including a multilayer substrate 102A according to a Second Embodiment. FIG. 3(B) is cross-sectional view of an antenna device including a multilayer substrate 102B according to the Second Embodiment.

FIG. 4(A) is a vertical cross-sectional view of a multilayer substrate 103A and FIG. 4(B) is a vertical cross-sectional view taken along line B-B in FIG. 4(A).

FIG. 5(A) is a vertical cross-sectional view taken along line Cs1-Cs1 in FIG. 4(A), and FIG. 5(B) is a vertical cross-sectional view taken along line Cs2-Cs2 in FIG. 4(A).

FIG. 6 is a plan view of a multilayer substrate 103B according to the Third Embodiment.

FIGS. 7(A) and 7(B) are diagrams illustrating the structure of a multilayer substrate 104 of an antenna device according to a Fourth Embodiment.

FIGS. 8(A) and 8(B) are diagrams illustrating the structure of a multilayer substrate 105 of an antenna device according to a Fifth Embodiment.

FIGS. 9(A), 9(B), and 9(C) are diagrams illustrating the structure of a multilayer substrate 106 of an antenna device according to a Sixth Embodiment.

FIG. 10 is a plan view illustrating the structure of a multilayer substrate 107 of an antenna device according to a Seventh Embodiment.

FIG. 11(A) is a plan view of a multilayer substrate 108 used as an antenna device according to an Eighth Embodiment, and FIG. 11(B) is a vertical cross-sectional view taken along line B-B in FIG. 11(A).

FIG. 12(A) is a plan view of a multilayer substrate 109 used as an antenna device according to a Ninth Embodiment, and FIG. 12(B) is a vertical cross-sectional view taken along line B-B in FIG. 12(A).

FIG. 13 is a block diagram illustrating the main components of an antenna device according to a Tenth Embodiment.

### DESCRIPTION OF EMBODIMENTS

Hereinafter, a plurality of modes for carrying out the present disclosure will be illustrated by giving several specific examples with reference to the drawings. The same reference numerals are used for the same parts in each drawing. In consideration of ease of explanation or understanding of the main points, a plurality of embodiments are illustrated in a separate manner for convenience of explanation, but parts of the configurations illustrated in different embodiments may be substituted for or combined with each other. From the Second Embodiment onwards, description of matters common to the First Embodiment are not repeated, and only the differences are described. In particular, the same or similar effects resulting from the same or similar configurations will not be repeatedly mentioned in each embodiment.

### First Embodiment

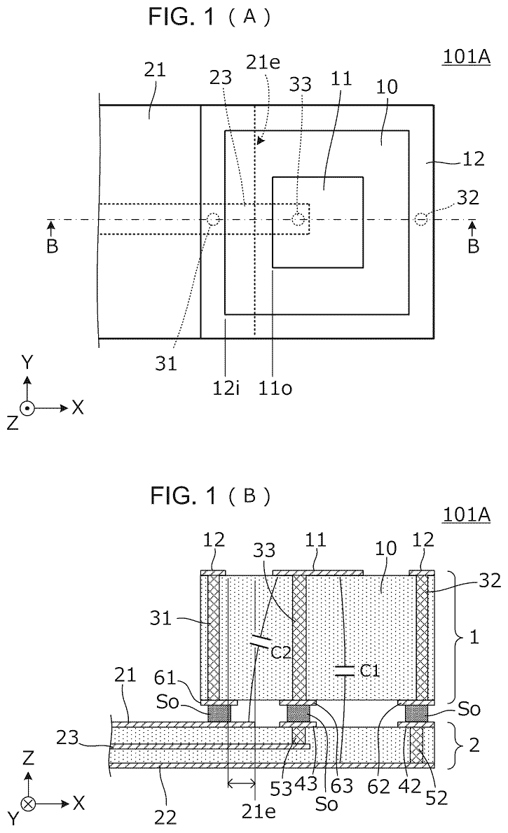

FIGS. 1(A) and 1(B) are diagrams illustrating the structure of a multilayer substrate of an antenna device according to a First Embodiment. FIG. 1(A) is a plan view of the multilayer substrate, and FIG. 1(B) is a vertical cross-sectional view taken along line B-B in FIG. 1(A). In FIG. 1(A) and FIG. 1(B), X, Y, and Z are symbols representing three orthogonal axial directions.

A multilayer substrate 101A includes an antenna section 1 and a transmission line section 2. The antenna section 1 and transmission line section 2 are multilayer bodies consisting of a plurality of dielectric base materials on which various conductor patterns are formed. As used herein, a “base material” refers to a dielectric layer or substrate, which may be rigid or flexible, on which conductive patterns are formed and which are stacked to form the multilayer substrate. In FIG. 1(B), each base material layer is not individually illustrated, as the entirety of each multilayer body is illustrated as a single unit.

The multilayer substrate 101A of this embodiment constitutes an antenna device including the transmission line section 2 and the antenna section 1 configured by soldering the antenna section 1 to the transmission line section 2.

The antenna section 1 includes a base material having a radiation conductor 11 provided on the upper surface thereof, and a base material having an upper-surface annular ground conductor 12 that surrounds the radiation conductor 11 in an annular fashion. Antenna-section ground terminals 61 and 62 and an antenna-section signal line terminal 63 are formed on the lower surface of the antenna section 1. The various conductors and terminals are composed of, for example, patterned copper foil.

The transmission line section 2 is a transmission line section for transmitting signals related to the antenna section 1. This transmission line section 2 forms a stripline including an upper ground conductor 21 close to the antenna section 1, a lower ground conductor 22 distant from the antenna section 1, and a signal line conductor 23 disposed between the upper ground conductor 21 and the lower ground conductor 22. A transmission-line-section ground conductor interlayer connection conductor 52 and a transmission-line-section signal line conductor interlayer connection conductor 53 are formed in the transmission line section 2. In addition, a signal line conductor terminal 43 and a ground conductor terminal 42 are formed on the upper surface of the transmission line section 2. The various conductors and terminals are composed of, for example, patterned copper foil.

The antenna-section ground terminal 61 of the antenna section 1 is soldered to the upper ground conductor 21 via solder So, the antenna-section ground terminal 62 is soldered to the ground conductor terminal 42 via solder So, and the antenna-section signal line terminal 63 is soldered to the signal line conductor terminal 43 via solder So.

The antenna section 1 includes a signal line conductor interlayer connection conductor 33 that electrically connects the radiation conductor 11 to the signal line conductor 23. The antenna section 1 also includes a ground conductor interlayer connection conductor 31 that electrically connects the upper-surface annular ground conductor 12 to the upper ground conductor 21 of the transmission line section 2. The antenna section also includes a ground conductor interlayer connection conductor 32 that electrically connects the upper-surface annular ground conductor 12 to the lower ground conductor 22 of the transmission line section 2. These interlayer connection conductors are interlayer connection conductors.

The entire surface of the radiation conductor 11 overlaps the lower ground conductor 22 when viewed in the stacking direction (Z direction) of the plurality of base materials. With this structure, an appropriate capacitance component (capacitance C1 illustrated in FIG. 1(B)) is formed between the lower ground conductor 22 and the radiation conductor 11.

In order to generate a small capacitance component between the radiation conductor 11 and the ground conductor to satisfy the radiation characteristics in the desired frequency band, it generally would be necessary to increase the thickness dimension of the antenna section 1. However, in this embodiment, since the distance between the radiation conductor 11 and the lower ground conductor 22 can be easily increased, the thickness dimension of the antenna section 1 can be reduced.

As illustrated in FIG. 1(A), an end portion 21e of the upper ground conductor 21 protrudes into the inside of the upper-surface annular ground conductor 12 when viewed in the stacking direction (Z direction) of the plurality of base materials.

Furthermore, the end portion 21e of the upper ground conductor 21 is disposed at a position inside the annular shape formed by the upper-surface annular ground conductor 12 so as to overlap the signal line conductor 23 but not overlap the radiation conductor 11. In other words, the end portion 21e of the upper ground conductor 21 is positioned between an inner periphery 12i of the upper-surface annular ground conductor 12 and an outer periphery 11 of the radiation conductor 11. With this structure, an unwanted capacitance (capacitance C2 illustrated in FIG. 1(B)) generated between the upper ground conductor 21 and the radiation conductor 11 can be reduced. With this structure, the capacitance C2 generated between the upper ground conductor 21 and the radiation conductor 11 can be reduced without increasing the thickness dimension of the antenna section 1.

As indicated by the double-headed arrow in FIG. 1(B), the end portion 21e of the upper ground conductor 21 protrudes toward the signal line conductor interlayer connection conductor 33 relative to the end portion of the antenna-section ground terminal 61 formed on the lower surface of the antenna section 1. Therefore, unwanted coupling between the signal line conductor 23 and the ground conductor interlayer connection conductor 31 or the antenna-section ground terminal 61 is also suppressed.

According to this embodiment, a multilayer substrate can be configured in which the transmission line section 2 has a stripline structure and the lower ground conductor 22 thereof also serves as part of the antenna section, and an antenna device including this multilayer substrate can be obtained.

Furthermore, by configuring the dimensions and structure of the upper ground conductor 21 as described above, an appropriate capacitance component is generated between the radiation conductor 11 and each ground conductor, and therefore there is no need to increase the thickness of the antenna section 1. In other words, the antenna section 1 can be made thinner.

Next, a multilayer substrate and an antenna device in which an antenna section and a transmission line section are stacked and integrated with each other will be exemplified.

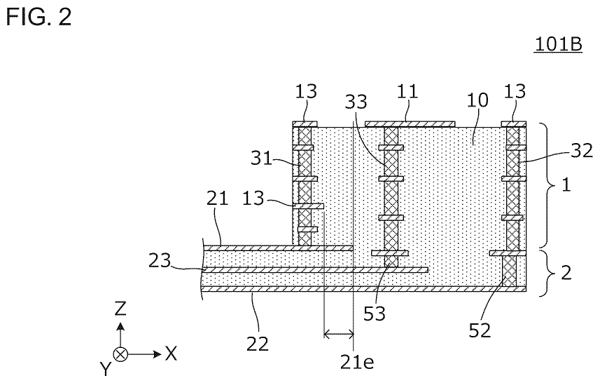

FIG. 2 is a vertical cross-sectional view of a multilayer substrate 101B according to the First Embodiment. The position of this cross section corresponds to FIG. 1(B).

The multilayer substrate 101B includes an antenna section 1 and a transmission line section 2, and is a multilayer body consisting of a plurality of dielectric base materials on which various conductor patterns are formed.

The antenna section 1 includes a base material having a radiation conductor 11 provided on the upper surface thereof, and a base material on which an annular ground conductor surrounding the radiation conductor 11 in an annular fashion is provided.

The transmission line section 2 is a transmission line section for transmitting signals related to the antenna section 1. This transmission line section 2 forms a stripline including an upper ground conductor 21 close to the antenna section 1, a lower ground conductor 22 distant from the antenna section 1, and a signal line conductor 23 disposed between the upper ground conductor 21 and the lower ground conductor 22. In addition, a transmission-line-section ground conductor interlayer connection conductor 52 and a transmission-line-section signal line conductor interlayer connection conductor 53 are formed in the transmission line section 2.

The antenna section 1 includes a signal line conductor interlayer connection conductor 33 that electrically connects the radiation conductor 11 to the signal line conductor 23. In addition, a plurality of ground conductors 13 and the ground conductor interlayer connection conductors 31 and 32 that electrically connect these ground conductors together in the stacking direction form an annular ground conductor.

In the examples illustrated in FIGS. 1(A) and 1(B), the ground conductors 13 and the ground conductor interlayer connection conductors 31 and 32 form an annular ground conductor, but, as disclosed in Patent Document 1, when an annular ground conductor is formed across multiple layers (by these multiple layers), the ground conductors 13 and the ground conductor interlayer connection conductors 31 and 32 correspond to parts of an “annular ground conductor” of the present disclosure.

As indicated by the double-headed arrow in FIG. 2, an end portion 21e of the upper ground conductor 21 protrudes toward the signal line conductor interlayer connection conductor 33 from the inside of the annular shape formed by the antenna-side ground conductor 13 formed in a lower part of the antenna section 1 and the ground conductor interlayer connection conductors 31 and 32.

The multilayer substrate 101B also achieves the same effects as multilayer substrate 101A.

### Second Embodiment

In a Second Embodiment, a multilayer substrate and an antenna device are exemplified in which an antenna section and a transmission line section are formed by a multilayer body consisting of base materials on and in which conductors are formed with the interlayer connection conductors being unevenly positioned when viewed in the stacking direction.

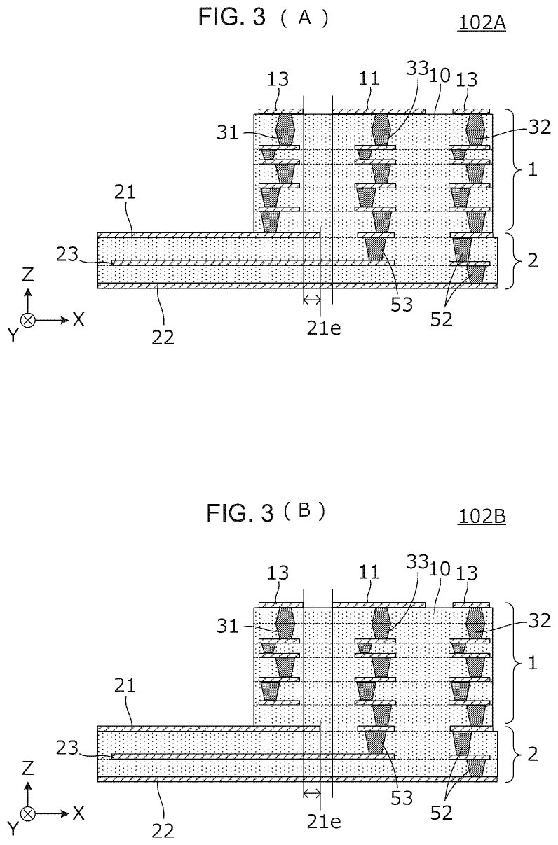

FIG. 3(A) is cross-sectional view of an antenna device including a multilayer substrate 102A according to a Second Embodiment. FIG. 3(B) is cross-sectional view of an antenna device including a multilayer substrate 102B according to the Second Embodiment.

The multilayer substrates 102A and 102B each include an antenna section 1 and a transmission line section 2, each consisting of a multilayer body of a plurality of dielectric base materials on which various conductor patterns are formed.

The antenna section 1 of the multilayer substrates 102A and 102B includes a base material having a radiation conductor 11 provided on an upper surface thereof, and base materials having ground conductors 13 and ground conductor interlayer connection conductors 31 and 32 that surround the radiation conductor 11 in an annular fashion provided thereon and therein.

The transmission line section 2 is a transmission line section for transmitting signals related to the antenna section 1. This transmission line section 2 forms a stripline including an upper ground conductor 21 close to the antenna section 1, a lower ground conductor 22 distant from the antenna section 1, and a signal line conductor 23 disposed between the upper ground conductor 21 and the lower ground conductor 22. In addition, a transmission-line-section ground conductor interlayer connection conductor 52 and a transmission-line-section signal line conductor interlayer connection conductor 53, which are interlayer connection conductors, are formed in the transmission line section 2.

The antenna section 1 includes a signal line conductor interlayer connection conductor 33 that electrically connects the radiation conductor 11 to the signal line conductor 23. The antenna section also includes an annular ground conductor including ground conductors 13 and ground conductor interlayer connection conductors 31 and 32. The signal line conductor interlayer connection conductor 33, the ground conductor interlayer connection conductors 31, and the ground conductor interlayer connection conductors 32 are multilayer bodies consisting of conductive foil such as copper foil and interlayer connection conductors.

The above-mentioned interlayer connection conductors are formed by, for example, solidifying a conductive paste.

In the multilayer substrates 102A and 102B of this embodiment as well, as in the case of the First Embodiment, when viewed in the stacking direction (Z direction) of the plurality of base materials, an end portion 21e of the upper ground conductor 21 is disposed inside the annular ground conductor including the ground conductors 13 and the ground conductor interlayer connection conductors 31 and 32 at a position that overlaps the signal line conductor 23 but does not overlap with the radiation conductor 11.

As illustrated in the Second Embodiment, if the positions of the interlayer connection conductors are dispersed when viewed in the stacking direction (Z direction) of the plurality of base materials, damage to the interlayer connection conductors due to bending stress of the transmission line section 2 can be made less likely to occur.

In the multilayer substrate 102A illustrated in FIG. 3(A), the ground conductor interlayer connection conductor 31 is connected to the upper ground conductor 21 via interlayer connection conductors, whereas in the multilayer substrate 102B illustrated in FIG. 3(B), there are no interlayer connection conductors between the ground conductor interlayer connection conductor 31 and the upper ground conductor 21. Although stress is concentrated at the boundary between the antenna section 1 and the transmission line section 2, the structure of the multilayer substrate 102B illustrated in FIG. 3(B) enables generation of cracks in portions where the stress is concentrated to be suppressed by eliminating the interlayer connection conductors in the portions where the stress is concentrated.

Furthermore, by eliminating the interlayer connection conductors, unwanted resonance due to extending of the upper ground conductor 21 can be prevented, even if a potential difference occurs between the ground conductors 13 and the ground conductor interlayer connection conductor 31.

### Third Embodiment

In a Third Embodiment, a multilayer substrate including an upper ground conductor having a different shape from that in the multilayer substrates exemplified thus far will be exemplified.

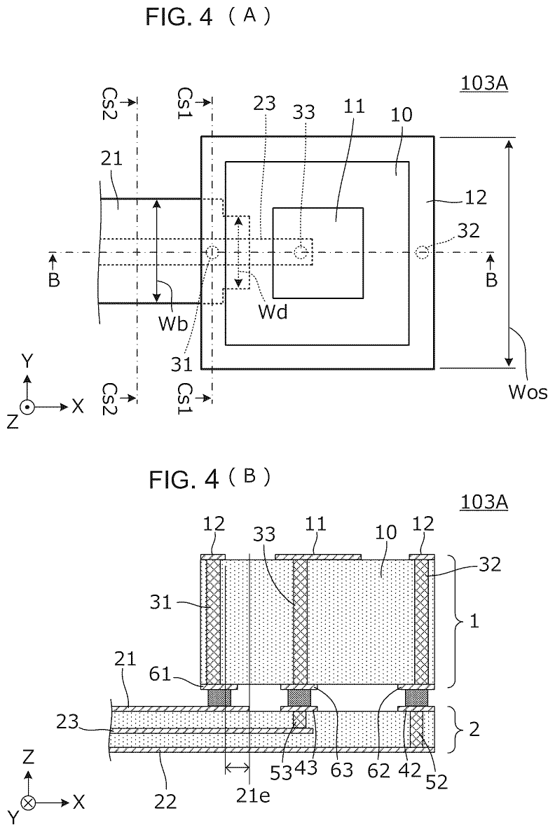

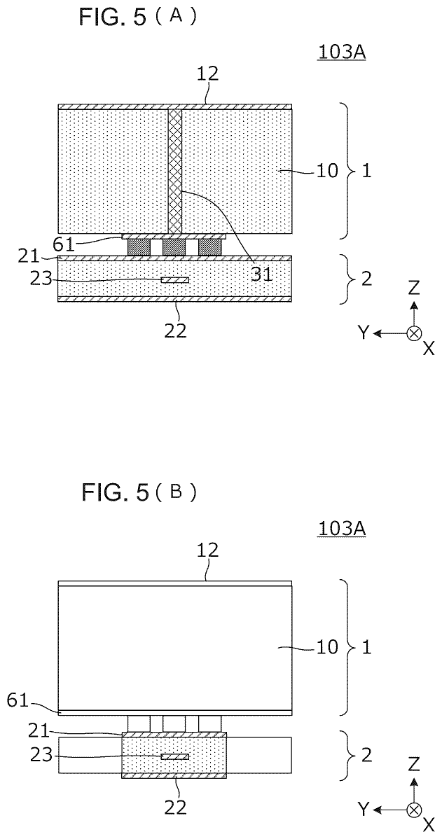

FIGS. 4(A), 4(B), 5(A), and 5(B) are diagrams illustrating the structure of a multilayer substrate 103A of an antenna device according to the Third Embodiment. FIG. 4(A) is a plan view of the multilayer substrate 103A, and FIG. 4(B) is a vertical cross-sectional view taken along line B-B in FIG. 4(A). FIG. 5(A) is a vertical cross-sectional view taken along line Cs1-Cs1 in FIG. 4(A), and FIG. 5(B) is a vertical cross-sectional view taken along line Cs2-Cs2 in FIG. 4(A). In FIGS. 4(A), 4(B), 5(A), and 5(B), X, Y, and Z are symbols representing three orthogonal axial directions.

The upper ground conductor 21 has a different shape to that in the multilayer substrate 101A illustrated in FIGS. 1(A) and 1(B) in the First Embodiment. In the multilayer substrate 103A according to the Third Embodiment, the width of the upper ground conductor 21 at a location inside the annular shape formed by the upper-surface annular ground conductor 12 includes a portion that is smaller than the width of the upper ground conductor 21 at a location outside the upper-surface annular ground conductor 12 when viewed in the stacking direction (Z direction) of the plurality of base materials.

In FIG. 4(A), a width Wd of the upper ground conductor 21 at a location inside the annular shape formed by the upper-surface annular ground conductor 12 is smaller than a width Wb of the upper ground conductor 21 at a location outside the upper-surface annular ground conductor 12. In the multilayer substrate 101A illustrated in FIG. 1(A), the width of the upper ground conductor 21 is the same as the outer width of the upper-surface annular ground conductor 12, whereas, in the example illustrated in FIG. 4(A), the width Wb of the upper ground conductor 21 at a location outside the upper-surface annular ground conductor 12 is smaller than an outer width Wos of the upper-surface annular ground conductor 12. Furthermore, as illustrated in FIGS. 5(A) and 5(B), the width of the lower ground conductor 22 is equal to the width Wos of the upper ground conductor 21. That is, the width of the lower ground conductor 22 at a location outside the upper-surface annular ground conductor 12 is also smaller than the outer width Wos of the upper-surface annular ground conductor 12. However, the shape of the lower ground conductor 22 is the same as the outer shape of the upper-surface annular ground conductor 12 when viewed in the stacking direction (Z direction) of the plurality of base materials. In the example illustrated in FIGS. 5(A) and 5(B), the antenna section 1 is soldered to the transmission line section 2 at three locations.

Although FIGS. 4(A), 4(B), 5(A), and 5(B) illustrate an example in which the antenna section 1 is soldered to the transmission line section 2, this embodiment can be similarly applied to a case in which the transmission line section 2 and the antenna section 1 are configured as an integrated multilayer body, as illustrated in FIG. 2.

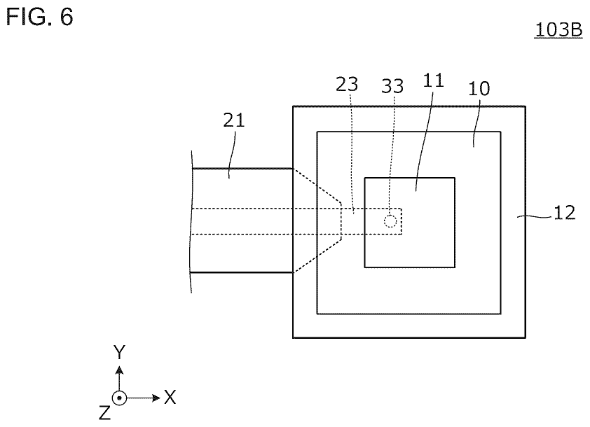

FIG. 6 is a plan view of a multilayer substrate 103B according to the Third Embodiment. In the multilayer substrate 103A illustrated in FIGS. 4(A), 4(B), 5(A), and 5(B), the width Wd of the upper ground conductor 21 at a location inside the annular shape formed by the upper-surface annular ground conductor 12 is constant inside the annular shape. However, in the example illustrated in FIG. 6, the width (width in the Y direction) of the upper ground conductor 21 at a location inside the annular shape formed by the upper-surface annular ground conductor 12 tapers in the X direction (forms a tapered shape). In the example illustrated in FIG. 6, a trapezoidal shape is formed.

According to the Third Embodiment, the upper ground conductor 21 extends with a minimum necessary width within the annular ground conductor, and therefore unwanted coupling (capacitance C2 illustrated in FIG. 1(B)) between the upper ground conductor 21 and the radiation conductor 11 can be reduced.

### Fourth Embodiment

In a Fourth Embodiment, a multilayer substrate including an upper ground conductor having a different shape from that in the multilayer substrates exemplified thus far will be exemplified.

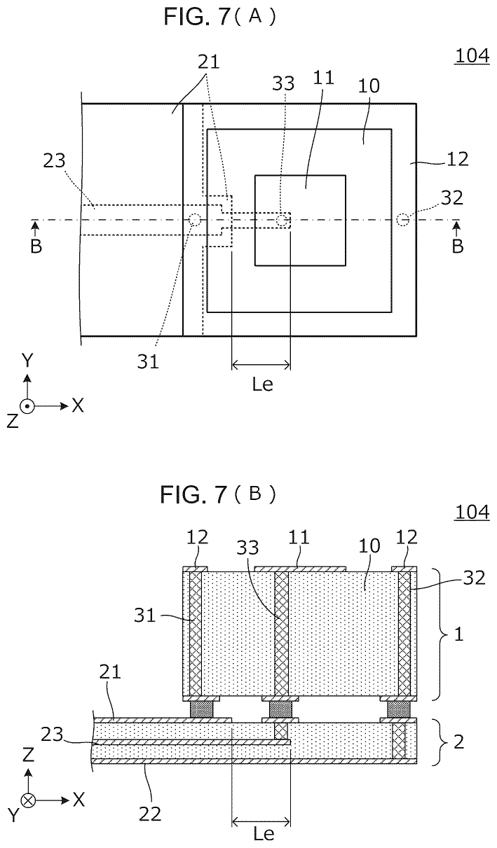

FIGS. 7(A) and 7(B) are diagrams illustrating the structure of a multilayer substrate 104 of an antenna device according to the Fourth Embodiment. FIG. 7(A) is a plan view of the multilayer substrate 104, and FIG. 7(B) is a vertical cross-sectional view taken along line B-B in FIG. 7(A).

The multilayer substrate 104 differs from the multilayer substrate 101A illustrated in FIGS. 1(A) and 1(B) in the First Embodiment in particular with respect to the shape of the signal line conductor 23. In the multilayer substrate 104 according to the Fourth Embodiment, when viewed in the stacking direction (Z direction), the line width (width in the Y direction) of a region having a length Le at the tip of the signal line conductor 23 is smaller than that of the main portion of the signal line conductor 23 overlapping the upper ground conductor 21.

According to this embodiment, it is possible to reduce unwanted coupling between the upper-surface annular ground conductor 12 and the signal line conductor 23. Furthermore, by setting the width of the signal line conductor 23 at a location facing the upper ground conductor 21 in the transmission line section 2 to a specified value, it is possible to set the transmission line section 2 to a desired characteristic impedance, and by reducing the line width of the signal line conductor 23 inside the upper-surface annular ground conductor 12, it is also possible to achieve impedance matching at the tip of the signal line conductor 23.

### Fifth Embodiment

In a Fifth Embodiment, a multilayer substrate including an upper ground conductor and a signal line conductor with different shapes from those in the multilayer substrates exemplified thus far will be exemplified.

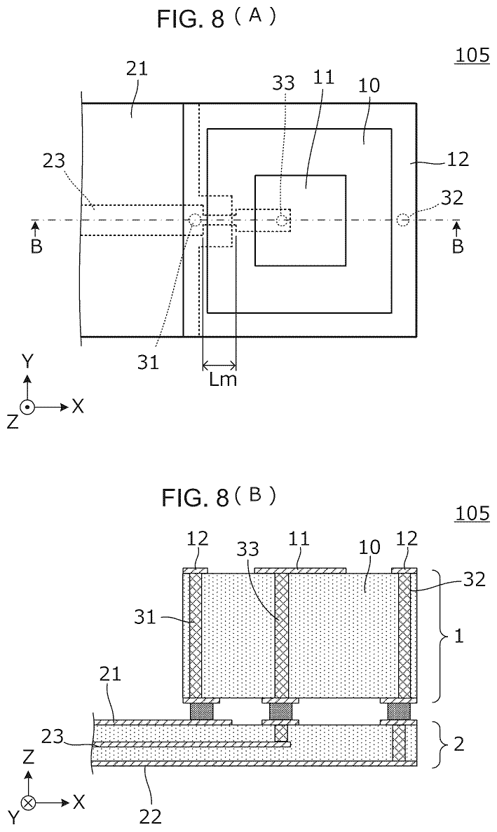

FIGS. 8(A) and 8(B) are diagrams illustrating the structure of a multilayer substrate 105 of an antenna device according to the Fifth Embodiment. FIG. 8(A) is a plan view of the multilayer substrate 105, and FIG. 8(B) is a vertical cross-sectional view taken along line B-B in FIG. 8(A).

The shapes of the upper ground conductor 21 and the signal line conductor 23 differ from those in the multilayer substrate 101A illustrated in FIGS. 1(A) and 1(B) in the First Embodiment. In the multilayer substrate 105 according to the Fifth Embodiment, when viewed in the stacking direction (Z direction), a middle portion of the signal line conductor 23 includes a portion, inside the annular shape formed by the upper-surface annular ground conductor 12, where the line width (width in the Y direction) of the signal line conductor 23 at a location overlapping the upper ground conductor 21 is smaller than the line width of the signal line conductor 23 at a location not overlapping the upper ground conductor 21.

In the example illustrated in FIG. 8(A), the middle portion of the signal line conductor 23 (portion Lm illustrated in FIG. 8(A)) is thinner than a portion around the center of the upper-surface annular ground conductor 12.

According to this embodiment, when viewed in the stacking direction (Z direction), the line width of the upper ground conductor 21 at a location facing the signal line conductor 23 is small at the narrowed portion of the signal line conductor 23, and as a result, unwanted coupling between the radiation conductor 11 and the upper ground conductor 21 can be reduced. Furthermore, by changing the width of the upper ground conductor 21 at the narrowed portion of the signal line conductor 23, impedance matching between the transmission line section 2 and the antenna section 1 can be realized.

### Sixth Embodiment

In a Sixth Embodiment, a multilayer substrate and an antenna device including a plurality of radiation electrodes used for different frequency bands will be exemplified.

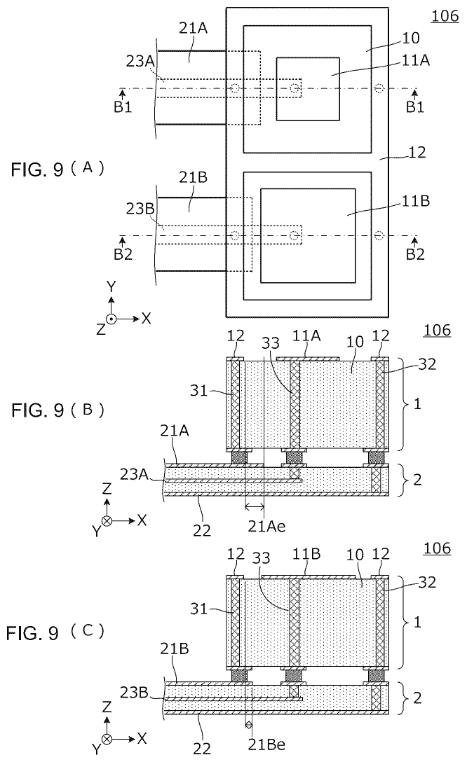

FIGS. 9(A), 9(B), and 9(C) are diagrams illustrating the structure of a multilayer substrate 106 of an antenna device according to the Sixth Embodiment. FIG. 9(A) is a plan view of the multilayer substrate, FIG. 9(B) is a vertical cross-sectional view taken along line B1-B1 in FIG. 9(A), and FIG. 9(C) is a vertical cross-sectional view taken along line B2-B2 in FIG. 9(A).

The multilayer substrate 106 includes an antenna section 1 and a transmission line section 2. The antenna section 1 and transmission line section 2 are multilayer bodies consisting of a plurality of dielectric base materials on which various conductor patterns are formed.

The multilayer substrate 106 of this embodiment constitutes an antenna device including the transmission line section 2 and the antenna section 1 configured by soldering the antenna section 1 to the transmission line section 2. In the First Embodiment, an antenna device is configured that includes a single radiation conductor 11, whereas in the Sixth Embodiment, an upper-surface annular ground conductor 12 including two annular ground conductor portions and two radiation conductors 11A and 11B are provided. When viewed in the stacking direction (Z direction), the radiation conductor 11A is smaller and the radiation conductor 11B is larger. The frequency band of the antenna constituted by the antenna section 1 including the radiation conductor 11A and the lower ground conductor 22 is, for example, the 5 GHz band, and the frequency band of the antenna constituted by the antenna section 1 including the radiation conductor 11B and the lower ground conductor 22 is, for example, the 2.4 GHz band.

As illustrated in FIGS. 9(B) and 9(C), when viewed in the stacking direction (Z direction) of the plurality of base materials, an end portion 21Ae of an upper ground conductor 21A is disposed at a position inside a first annular shape formed by the upper-surface annular ground conductor 12 so as to overlap a signal line conductor 23A but not overlap the radiation conductor 11A. Furthermore, an end portion 21Be of an upper ground conductor 21B is disposed at a position inside a second annular shape formed by the upper-surface annular ground conductor 12 so as to overlap a signal line conductor 23B but not overlap the radiation conductor 11B.

Thus, when antennas operating in different frequency bands are used in combination with each other, the protrusion length of the upper ground conductor 21B toward the inside of the annular ground conductor (in this example, the upper-surface annular ground conductor 12) for the antenna operating in the lower frequency band is relatively shorter due to the positional relationship of the feeding point to the radiating element when viewed in the stacking direction. The lower the frequency, the less likely coupling is to occur between the signal line and the annular ground conductor, and therefore the protrusion length can be short. By shortening the protrusion length in this way, unwanted capacitive coupling between the protruding portion of the upper ground conductor 21B and the radiation conductor 11B can be suppressed.

### Seventh Embodiment

In a Seventh Embodiment, a multilayer substrate and an antenna device in which multiple transmission line sections are connected to a single antenna section will be exemplified.

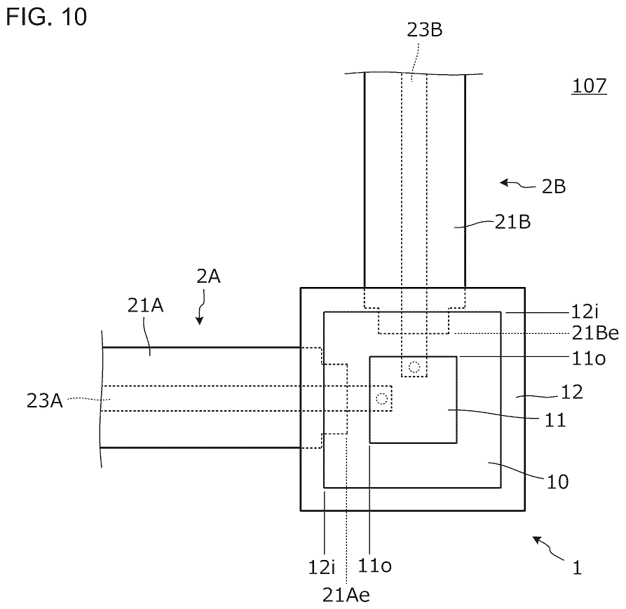

FIG. 10 is a plan view illustrating the structure of a multilayer substrate 107 of an antenna device according to the Seventh Embodiment.

The multilayer substrate 107 includes an antenna section 1 and transmission line sections 2A and 2B. The antenna section 1 and the transmission line sections 2A and 2B each consist of a multilayer body of a plurality of dielectric base materials on which various conductor patterns are formed.

In this embodiment, two transmission line sections 2A and 2B are provided for a single antenna section 1, and the signal lines of the two transmission line sections 2A and 2B are connected to a plurality of feeding points of the radiation conductor 11.

In FIG. 10, when viewed in the stacking direction of the multiple base materials, the end portion 21Ae of the upper ground conductor 21A is disposed at a position inside the annular shape formed by the upper-surface annular ground conductor 12 so as to overlap the signal line conductor 23A but not overlap the radiation conductor 11. In other words, the end portion 21Ae of the upper ground conductor 21A is located between the inner periphery 12i of the upper-surface annular ground conductor 12 and the outer periphery 11 of the radiation conductor 11. Similarly, the end portion 21Be of the upper ground conductor 21B is located between the inner periphery 12i of the upper-surface annular ground conductor 12 and the outer periphery 11 of the radiation conductor 11.

In this embodiment, since the feeding point used for the radiation conductor 11 can be selected, the antenna can also be used as an orthogonal polarization or circular polarization antenna.

As exemplified in this embodiment, the structures illustrated in the first to Sixth Embodiments can also be applied to an antenna device that includes a single radiation conductor 11 and a single upper-surface annular ground conductor 12, but also includes multiple signal line conductors.

### Eighth Embodiment

In an Eighth Embodiment, an antenna device including parasitic elements will be exemplified.

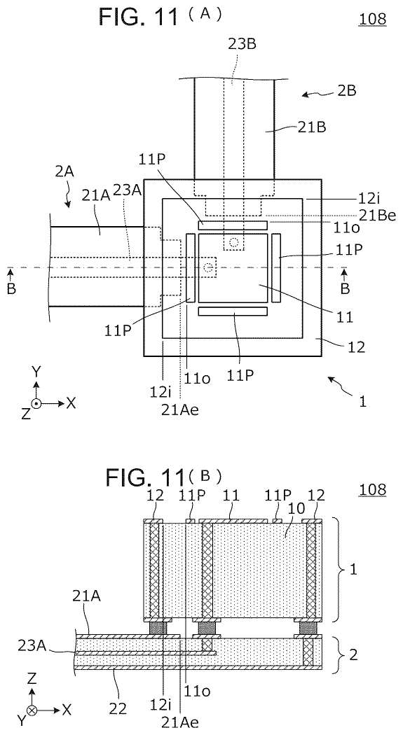

FIG. 11(A) is a plan view of a multilayer substrate 108 used as an antenna device according to the Eighth Embodiment, and FIG. 11(B) is a vertical cross-sectional view taken along line B-B in FIG. 11(A).

In this embodiment, parasitic elements 11P are disposed around the radiation element (feed element) 11.

Furthermore, in the multilayer substrate 108 of this embodiment, the radiation conductor 11 is structured to be fed at two feeding points, similarly to the example illustrated in FIG. 10.

In FIG. 11, when viewed in the stacking direction (Z direction) of the plurality of base materials, the end portion 21Ae of the upper ground conductor 21A is disposed at a position inside the annular shape formed by the upper-surface annular ground conductor 12 so as to overlap the signal line conductor 23A but not overlap the parasitic elements 11P. That is, the end portion 21Ae of the upper ground conductor 21A is located between the inner periphery of the upper-surface annular ground conductor 12 and the parasitic elements 11P. Similarly, the end portion 21Be of the upper ground conductor 21B is disposed at a position inside the annular shape formed by the upper-surface annular ground conductor 12 so as to overlap the signal line conductor 23B but not overlap the parasitic element 11P. That is, the end portion 21Be of the upper ground conductor 21B is located between the inner periphery of the upper-surface annular ground conductor 12 and the parasitic elements 11P.

This structure achieves the same effects as described in the First Embodiment etc. Furthermore, according to this embodiment, by disposing the parasitic elements 11P around the radiation conductor 11, the resonant frequency due to these elements can be increased, thereby widening the bandwidth.

### Ninth Embodiment

In a Ninth Embodiment, an antenna device including a parasitic element different from the example illustrated in the Eighth Embodiment will be illustrated.

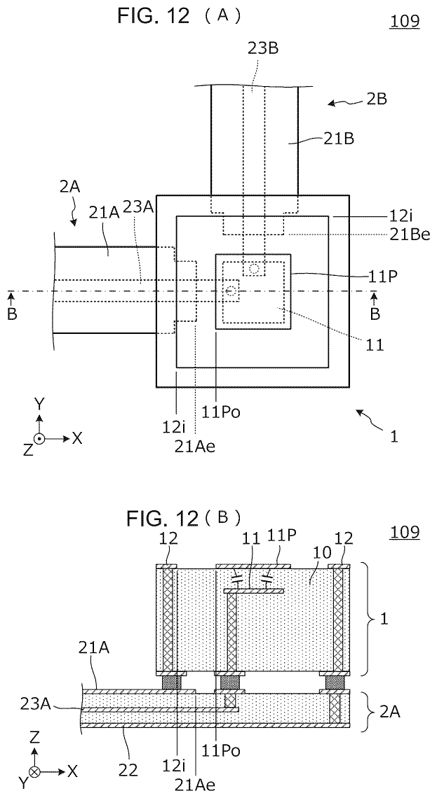

FIG. 12(A) is a plan view of a multilayer substrate 109 used as an antenna device according to the Ninth Embodiment, and FIG. 12(B) is a vertical cross-sectional view taken along line B-B in FIG. 12(A).

In this embodiment, a radiation conductor (feed element) 11 is provided inside a multilayer body 10 of base materials of an antenna section, and a parasitic element 11P having a relatively larger area than the radiation conductor 11 is disposed on the surface side relative to the radiation conductor 11. Furthermore, in the multilayer substrate 109 of this embodiment, the radiation conductor 11 is structured to be fed at two feeding points, similarly to as in the examples illustrated in FIGS. 10 and 11. As illustrated in FIG. 12(B), there is capacitive coupling between the radiation conductor 11 and the parasitic element 11P.

In FIG. 12, when viewed in the stacking direction (Z direction) of the plurality of base materials, the end portion 21Ae of the upper ground conductor 21A is disposed at a position inside the annular shape formed by the upper-surface annular ground conductor 12 so as to overlap the signal line conductor 23A but not overlap the parasitic element 11P. That is, the end portion 21Ae of the upper ground conductor 21A is located between the inner periphery of the upper-surface annular ground conductor 12 and the parasitic element 11P. Similarly, the end portion 21Be of the upper ground conductor 21B is disposed at a position inside the annular shape formed by the upper-surface annular ground conductor 12 so as to overlap the signal line conductor 23B but not overlap the parasitic element 11P. That is, the end portion 21Be of the upper ground conductor 21B is located between the inner periphery of the upper-surface annular ground conductor 12 and the parasitic element 11P.

This structure achieves the same effects as described in the First Embodiment etc. Furthermore, according to this embodiment, by disposing the parasitic element 11P, which is capacitively coupled to the radiation conductor 11, the resonant frequency due to these elements can be increased, thereby widening the bandwidth.

### Tenth Embodiment

In a Tenth Embodiment, an antenna device according to the present disclosure will be exemplified.

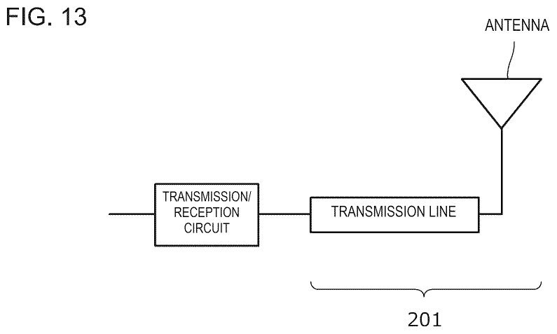

FIG. 13 is a block diagram illustrating the main configuration of an antenna device according to this embodiment. This antenna device 201 includes a transmission/reception circuit and an antenna. The transmission line and antenna are constituted by a multilayer substrate according to the present disclosure, and are constituted by the multilayer substrate illustrated in any of the first to Ninth Embodiments. The transmission/reception circuit handles radio-frequency signals in the 1 GHz band to the 1 THz band, for example.

Finally, the present disclosure is not limited to the above-described embodiments. Those skilled in the art can make appropriate modifications and changes. The scope of the present disclosure is defined not by the above-described embodiments but by the claims. Furthermore, the scope of the present disclosure includes modifications and changes from the embodiments within the scope of the claims and their equivalents.

A multilayer substrate and an antenna device of the present disclosure may be provided in the following forms.

<1>

A multilayer substrate comprising:
an antenna section in which a plurality of base materials are stacked on top of one another, the base materials including a base material provided with a radiation conductor and a base material provided with an annular ground conductor surrounding the radiation conductor in an annular fashion; and a transmission line section configured to transmit signals related to the antenna section,
wherein the transmission line section forms a stripline including an upper ground conductor close to the antenna section, a lower ground conductor distant from the antenna section, and a signal line conductor disposed between the upper ground conductor and the lower ground conductor,
the antenna section includes a signal line conductor interlayer connection conductor that electrically connects the radiation conductor to the signal line conductor, and ground conductor interlayer connection conductors that electrically connect the annular ground conductor to the lower ground conductor and the upper ground conductor of the transmission line section,
when viewed in a stacking direction of the plurality of base materials, an entire surface of the radiation conductor overlaps the lower ground conductor, and
when viewed in the stacking direction, an end portion of the upper ground conductor is disposed inside an annular shape formed by the annular ground conductor at a position that overlaps the signal line conductor but does not overlap the radiation conductor.
   <2>

The multilayer substrate according to <1>,
wherein the ground conductor interlayer connection conductor, which electrically connects the annular ground conductor to the upper ground conductor of the transmission line section, is not present at a cross-sectional position along the signal line conductor.
   <3>

The multilayer substrate according to <1> or <2>,
wherein, when viewed in the stacking direction, a width of the upper ground conductor at a location inside the annular shape formed by the annular ground conductor includes a portion that is narrower than a width of the upper ground conductor at a location outside the annular ground conductor.
   <4>

The multilayer substrate according to any one of <1> to <3>
wherein, when viewed in the stacking direction, a line width of the signal line conductor at a location inside the annular shape formed by the annular ground conductor and not overlapping the upper ground conductor includes a portion that is narrower than a line width of the signal line conductor at a location overlapping the upper ground conductor.
   <5>

The multilayer substrate according to any one of <1> to <4>,
wherein, when viewed in the stacking direction, a line width of the signal line conductor at a location inside the annular shape formed by the annular ground conductor and overlapping the upper ground conductor includes a portion that is narrower than a line width of the signal line conductor at a location not overlapping the upper ground conductor.
   <6>

The multilayer substrate according to any one of <1> to <5>,
wherein the antenna section is configured by a plurality of antenna sections formed on predetermined base materials among the plurality of base materials and used at different frequencies,
the transmission line section is configured by the transmission line section provided for each of the plurality of antenna sections, and
when viewed in the stacking direction, a protrusion length of the upper ground conductor toward an inside of the annular ground conductor is greater for an antenna section for a higher frequency band than for an antenna section for a lower frequency band among the antenna sections.
   <7>

The multilayer substrate according to any one of <1> to <6>,
wherein a single one of the antenna sections is provided for a plurality of the transmission line sections,
signal lines of the plurality of transmission line sections are connected to a plurality of feeding points of the radiation conductor, and
when viewed in the stacking direction, an end portion of the upper ground conductor is disposed inside the annular ground conductor at a position overlapping the signal line conductor but not overlapping the radiation conductor.
   <8>

The multilayer substrate according to any one of <1> to <7>, further comprising:
a parasitic element formed on a base material on which the radiation conductor is formed or on a base material different from the base material on which the radiation conductor is formed,
wherein when viewed in the stacking direction, the parasitic element does not overlap the radiation conductor at a location inside the annular ground conductor.
   <9>

An antenna device comprising: the multilayer substrate according to any one of <1> to <8>,
wherein the antenna device is connected to a communication circuit.

### REFERENCE SIGNS LIST

So . . . solder
1 . . . antenna section
2 . . . transmission line section
2A, 2B . . . transmission line section
10 . . . multilayer body of base materials of antenna section
11, 11A, 11B . . . radiation conductor
11P . . . parasitic element
12 . . . upper-surface annular ground conductor
13 . . . ground conductor
21, 21A, 21B . . . upper ground conductor
21e . . . end portion of upper ground conductor
21Ae . . . end portion of upper ground conductor 21A
21Be . . . end portion of upper ground conductor 21B
22 . . . lower ground conductor
23, 23A, 23B . . . signal line conductor
31, 32 . . . ground conductor interlayer connection conductor
33 . . . signal line conductor interlayer connection conductor
42 . . . ground conductor terminal
43 . . . signal line conductor terminal
52 . . . transmission-line-section ground conductor interlayer connection conductor
53 . . . transmission-line-section signal line conductor interlayer connection conductor
61, 62 . . . antenna-section ground terminal
63 . . . antenna-section signal line terminal
101A, 101B, 102A, 102B, 103A, 103B, 104, 105, 106, 107, 108, 109 . . . multilayer substrate
201 . . . antenna device

1. A multilayer substrate comprising:
an antenna section in which a plurality of base materials are stacked on top of one another, the plurality of stacked base materials including a first base material having a radiation conductor and a second base material having an annular ground conductor surrounding the radiation conductor; and
a transmission line section configured to transmit a signal to or from the antenna section,
wherein
the transmission line section forms a stripline including an upper ground conductor to the antenna section, a lower ground conductor, the lower ground conductor being distant from the antenna section, and a signal line conductor between the upper ground conductor and the lower ground conductor,
the antenna section includes a signal line conductor interlayer connection conductor that electrically connects the radiation conductor to the signal line conductor, and one or more ground conductor interlayer connection conductors that electrically connect the annular ground conductor to the lower ground conductor and the upper ground conductor,
in plan view along a stacking direction of the plurality of base materials,
an entire surface of the radiation conductor overlaps the lower ground conductor, and
an end portion of the upper ground conductor is disposed between an inner periphery the annular ground conductor and an outer periphery of the radiation conductor, the end portion overlapping the signal line conductor and not overlapping the radiation conductor.

2. The multilayer substrate according to claim 1,
wherein the one or more ground conductor interlayer connection conductors that electrically connect the annular ground conductor to the upper ground conductor are absent at a cross-sectional position along the signal line conductor.

3. The multilayer substrate according to claim 1,
wherein, in the plan view, a width of the upper ground conductor at a location between the inner periphery of the annular ground conductor and the outer periphery of the radiation conductor is narrower than a width of the upper ground conductor at a location outside the annular ground conductor.

4. The multilayer substrate according to claim 3, wherein the upper ground conductor at the location between the inner periphery of the annular ground conductor and the outer periphery of the radiation conductor has a tapered shape.

5. The multilayer substrate according to claim 4, wherein the tapered shape is a trapezoidal shape.

6. The multilayer substrate according to claim 1,
wherein, in the plan view, a line width of the signal line conductor at a first location inside the annular shape formed by the annular ground conductor and not overlapping the upper ground conductor includes a portion that is narrower than a line width of the signal line conductor at a second location overlapping the upper ground conductor.

7. The multilayer substrate according to claim 1,
wherein, in the plan view, a line width of the signal line conductor at a first location between the inner periphery of the annular ground conductor and the outer periphery of the radiation conductor, overlapping the upper ground conductor is narrower than a line width of the signal line conductor at a second location not overlapping the upper ground conductor.

8. The multilayer substrate according to claim 1,
wherein
the antenna section includes a plurality of antenna sub-sections each configured for a different frequency band,
the transmission line section includes a plurality of transmission line sub-sections each corresponding to one of the plurality of antenna sub-sections, and
in the plan view, a protrusion length of the upper ground conductor into the annular ground conductor is greater for an antenna sub-section for a higher frequency band than for an antenna sub-section for a lower frequency band.

9. The multilayer substrate according to claim 1,
wherein a single antenna section is provided for a plurality of the transmission line sections,
signal line conductors of the plurality of transmission line sections are connected to a plurality of feeding points of the radiation conductor, and
for each of the plurality of transmission line sections, an associated end portion of an associated upper ground conductor is disposed between the inner periphery of the annular ground conductor and the outer periphery of the radiation conductor.

10. The multilayer substrate according to claim 1, further comprising:
a parasitic element on one of the plurality of stacked base materials,
wherein, in the plan view, the parasitic element is between the inner periphery of the annular ground conductor and the outer periphery of the radiation conductor.

11. The multilayer substrate according to claim 10, wherein the parasitic element is capacitively coupled to the radiation conductor.

12. The multilayer substrate according to claim 10, wherein the radiation conductor is within the plurality of stacked base materials, and the parasitic element is on a surface of the antenna section.

13. An antenna device comprising:
the multilayer substrate according to claim 1,
wherein the antenna device is connected to a communication circuit.

14. An antenna device comprising:
a communication circuit; and
a multilayer substrate connected to the communication circuit, the multilayer substrate including:
an antenna section including a radiation conductor and an annular ground conductor defining a plane; and
a transmission line section connected to the communication circuit and configured to feed the antenna section, the transmission line section including:
a lower ground conductor;
an upper ground conductor disposed between the lower ground conductor and the antenna section; and
a signal line conductor disposed between the upper and lower ground conductors, the signal line conductor electrically connected to the radiation conductor,
wherein,
when viewed normal to the plane of the annular ground conductor, the radiation conductor is entirely within a perimeter of the lower ground conductor, and
an end of the upper ground conductor extends into a region between an inner perimeter of the annular ground conductor and an outer perimeter of the radiation conductor.

15. A multilayer substrate, comprising:
an antenna section including a radiation conductor and a surrounding annular ground conductor; and
a transmission line section forming a stripline with an upper ground conductor, a lower ground conductor, and a signal line conductor therebetween, the signal line conductor extending from the transmission line section to connect to the radiation conductor, wherein
the lower ground conductor extends beneath both the transmission line section and the antenna section to form a ground plane for the radiation conductor, and
wherein the upper ground conductor extends from the transmission line section to a terminal end located in a space between the annular ground conductor and the radiation conductor, such that the upper ground conductor overlaps a portion of the signal line conductor that is within an outer boundary of the annular ground conductor.
